(19) United States
(12) Patent Application Publication
(10) Pub. No.: US 2025/0067313 A1
(43) Pub. Date: Feb. 27, 2025

(54) MULTIPLE-PISTON DISENGAGEMENT SYSTEM FOR ACTUATING A BRAKE DEVICE OF A VEHICLE, AND BRAKE ASSEMBLY FOR A VEHICLE COMPRISING THE MULTIPLE-PISTON DISENGAGEMENT SYSTEM

(71) Applicant: Schaeffler Technologies AG & Co. KG, Herzogenaurach (DE)

(72) Inventor: Simon Ortmann, Pulheim (DE)

(73) Assignee: Schaeffler Technologies AG & Co. KG, Herzogenaurach (DE)

(21) Appl. No.: 18/722,880

(22) PCT Filed: Jan. 13, 2023
(86) PCT No.: PCT/DE2023/100018

§ 371 Date: Jun. 21, 2024

(30) Foreign Application Priority Data
Jan. 18, 2022 (DE) 10 2022 101 041.4

(51) Int. Cl. F16D 65/18; B60T 1/06; F16D 55/40; F16D 121/04; F16D 127/02

(52) U.S. Cl. CPC F16D 65/186; B60T 1/065; F16D 55/40; F16D 2121/04; F16D 2127/02

(57) ABSTRACT

A multi-piston disengagement system for actuating a vehicle braking device includes an annular housing, a plurality of hydraulic actuation assemblies, and a force distribution device. The annular housing includes a main axis that defines an axial direction and a plurality of housing sections with respective pressure chambers arranged for filling with a fluid. Each of the hydraulic actuation assemblies has a piston arranged axially movable in a one of the respective pressure chambers and, when a hydraulic pressure is applied, arranged to apply an actuation force. The force distribution device is for distributing the actuation forces from respective pistons to the vehicle braking device.

### CROSS-REFERENCE TO RELATED APPLICATIONS

This application is the United States National Phase of PCT Appln. No. PCT/DE2023/100018 filed Jan. 13, 2023, which claims priority to German Application No. DE102022101041.4 filed Jan. 18, 2022, the entire disclosures of which are incorporated by reference herein.

### TECHNICAL FIELD

The present disclosure relates to a multi-piston disengagement system for actuating a braking device of a vehicle, and to a brake arrangement for a vehicle having said multi-piston disengagement system.

### BACKGROUND

Piston disengagement systems for actuating clutches or brakes in an electric drive train of a vehicle are well known from the prior art. For example, document DE 10 2020 104 771 A1 describes a slave cylinder for a disengagement system of a vehicle having a housing which forms a pressure chamber and having a piston which is arranged to be axially movable in the pressure chamber. In order to operate a clutch, the piston can introduce an actuation force into the clutch.

### SUMMARY

The present disclosure provides a multi-piston disengagement system which is designed to actuate a braking device, wherein the braking device is a component of a braking system of the vehicle. For example, the braking device is a wet-running multi-disc service brake, which can be arranged or is arranged within a wet space of an electric vehicle or hybrid vehicle. The vehicle may be an electric vehicle, e.g., an electrically or hybrid powered car or commercial vehicle.

The multi-piston disengagement system includes an annular housing. The annular housing has a main axis that defines an axial direction. In particular, the annular housing is arranged concentrically to the main axis.

The annular housing may have a circumferential flow channel, a fluid inlet and several pressure chambers which are fluidically connected to one another. A fluid, in particular a hydraulic fluid, can be introduced into the flow channel through the fluid inlet and flow from there into the pressure chambers.

The annular housing includes several housing sections. Exactly one pressure chamber may be arranged in each housing section, in particular integrated into the housing section and/or formed therein.

The multi-piston disengagement system includes multiple hydraulic actuation assemblies, having a plurality of piston assemblies, for example. The actuation assemblies may be arranged at a distance from one another at regular intervals in the circumferential direction around the annular housing. The annular housing and the resulting ring-shaped multi-piston disengagement systems can be integrated into the brake arrangement in a space-saving manner.

Each actuation assembly is assigned to exactly one housing section of the annular housing. Each actuation assembly includes exactly one piston assembly with one piston. The piston is arranged to be axially movable in the pressure chamber. When hydraulic pressure is applied, the piston can perform an actuation stroke to introduce an actuation force into the braking device. In particular, during and/or after the carrying out of the actuation stroke, the piston introduces a compressive force as an actuation force into a disc pack of the braking device, and the disc pack includes a plurality of friction discs. The actuation force causes the friction discs to be pressed together in a frictional manner to generate a braking force for braking a wheel of the vehicle. For example, the multi-piston disengagement system includes four, six or eight piston assemblies with a total of four, six or eight pistons.

Each actuation assembly may have a spring assembly which includes a return device. The return device may be designed to return the piston in an axially opposite direction. In particular, the piston performs a return stroke when it is returned by means of the return device.

According to the disclosure, the multi-piston disengagement system includes a force distribution device. The force distribution device is designed to distribute the actuation force introduced into the braking device, in particular in the circumferential direction around the annular housing.

It is a consideration of the disclosure that the friction discs of the plate pack must be subjected to the actuation force evenly in relation to their surface area in order to avoid so-called hotspots, in particular to avoid partial overloading of linings and friction surfaces of the friction discs and an associated underloading of other points. The force distribution device allows the actuation force to be distributed across several locations on the friction discs, thus preventing the formation of such hotspots.

In an example embodiment, the force distribution device is designed to introduce the actuation force into the braking device in a plurality of force introduction regions. The force distribution device may include the force introduction regions.

In a further embodiment, the number of force introduction regions is a multiple, e.g., double or triple, of a number of pistons of the multi-piston disengagement system. For example, the number of force introduction regions when hydraulically pressurizing the pistons up to a certain limit pressure is twice the number of existing pistons. For example, the number of force introduction regions may be three times the number of pistons present when the hydraulic pressurization of the pistons exceeds the limit pressure.

A structural implementation provides that the force distribution device includes a force distribution ring. The force distribution ring can be arranged and/or is arranged coaxially and/or concentrically to the annular housing in relation to the main axis. The force introduction regions may be arranged on the force distribution ring, e.g., on an upper side of the force distribution ring pointing in the axial direction.

A further embodiment provides that the force distribution device carries out the actuation stroke together with the pistons. For example, the force distribution device may be arranged directly in the axial direction in front of the piston. The force distribution device may be transferred into a contact position with the braking device when the pistons carry out the actuation stroke. During the forward stroke, the pistons may press against the force distribution device and move it into the contact position. The actuation force of the pistons may be introduced into the braking device by means of the force distribution device when the force distribution device is arranged in the contact position. Alternatively or optionally in addition, the force distribution device can be operatively connected to the pistons for transferring to the contact position and for transmitting the actuation force.

A possible implementation provides that several force introduction regions of the force distribution device are spatially and functionally assigned to each piston assembly. Each piston assembly may be assigned three force introduction regions. This means that the force introduction regions are arranged in the axial direction in front of the respective spatially assigned piston assembly so that they can multiply, in particular double or triple, the actuation force of the respective piston.

In a possible structural embodiment, the force introduction regions are formed by teeth. The teeth on the force distribution ring may be arranged at a distance from one another. The teeth may protrude from the top of the force distribution ring in the axial direction.

A structural embodiment provides that some teeth have a first height and the other teeth have a second height, and the first height differs from the second height. The first height may be greater than the second height. For example, some teeth are higher than the other teeth.

In a possible implementation, several teeth are spatially and functionally assigned to each piston assembly. For example, each piston assembly is spatially and functionally assigned a total of three teeth, with one of these teeth being less high than the other two teeth. Optionally, the tooth with the second, lower height is arranged immediately in front of the piston in the axial direction. Two teeth with the first, greater height may be arranged at a distance on either side of the tooth with the second height. The force distribution device may have a marking by means of which it can be correctly positioned relative to the actuation assembly, in particular to the piston, as described above.

Due to the spatial and functional assignment of the teeth to the respective piston, the actuation force can be distributed and harmonized. For example, the actuation force can be distributed to the two teeth or to all three teeth depending on the pressure of the hydraulic pressurization. In particular, the actuation force is distributed across the three teeth and thus harmonized when the hydraulic pressurization of the pistons exceeds the limit pressure.

In an example embodiment, the force distribution device has centering sections, by means of which the force distribution device can be arranged concentrically relative to the annular housing. The centering sections may be arranged at a distance from one another in the circumferential direction on the force distribution ring, protruding radially therefrom. For example, the centering sections are designed as toothing regions for engagement with corresponding toothings of a housing of the brake arrangement. In particular, the housing surrounds the wet space or is arranged in the wet space.

In a further embodiment, each actuation assembly includes a retaining plate. The retaining plate may be placed in the axial direction on the housing section of the respective actuation assembly. In particular, the retaining plate is connected to the housing section in a force-fitting and/or form-fitting manner, for example by being screwed thereto.

In a possible constructive implementation, the spring assembly includes a spring sheet, a spring plate and a spiral spring. The spring plate may be connected to the spring sheet in a form-fitting and/or force-fitting manner. The spiral spring may be arranged between the spring plate and the retaining plate. In particular, the spiral spring is supported in the axial direction on the retaining plate and in the opposite direction on the spring plate.

In a further possible constructive implementation, the spring assembly is operatively connected to the piston assembly so that the piston assembly entrains the spring assembly when carrying out the actuation stroke and the return stroke. For example, the piston is connected to the spring sheet in a form-fitting and/or force-fitting manner. The piston may press against the spring plate when it carries out the actuation stroke. As a result, the spring sheet and the spring plate attached thereto are moved in the axial direction against the preload of the spiral spring. When the hydraulic pressure on the piston is released, the piston is returned by the preload of the coil spring. In particular, the spiral spring serves as a return device.

The present disclosure also includes a braking system for a vehicle with the multi-piston disengagement system according to the previous description. The braking system includes a braking device for braking a wheel of the vehicle. The braking device may be designed according to the above description.

In an example embodiment, when it is arranged in the contact position, the force distribution device is arranged in contact with the braking device in some or all force introduction regions depending on a pressure of the hydraulic pressurization of the pistons. For example, two force introduction regions, e.g., the two teeth with the first, greater height, contact the braking device when the hydraulic pressurization of the pistons takes place with a pressure until the limit pressure is reached. In this case, the actuation force is distributed over the two teeth with the first height and transmitted to the braking device. If the limit pressure is exceeded when the pistons are hydraulically pressurized, the pistons move further and press harder against the force distribution device. This means that the tooth with the second, lower height also contacts the braking device. In this case, the actuation force is distributed across the three teeth of each actuation assembly and transferred to the braking device.

### BRIEF DESCRIPTION OF THE DRAWINGS

Further features, advantages and effects of the disclosure arise from the following description of exemplary embodiments. In the figures:

FIG. 1 shows a perspective plan view of a multi-piston disengagement system for actuating a braking device of a vehicle with several hydraulic actuation assemblies;

FIG. 2 shows an axial section through an annular housing of the multi-piston disengagement system:

FIG. 3 shows a perspective plan view of a force distribution device of the multi-piston disengagement system:

FIG. 4 shows a sectional view of a hydraulic actuation assembly of the multi-piston disengagement system with the force distribution device; and

FIG. 5 shows a braking device which can be actuated by the hydraulic actuation assemblies.

### DETAILED DESCRIPTION

Corresponding or identical parts are designated with the same reference symbols in the figures.

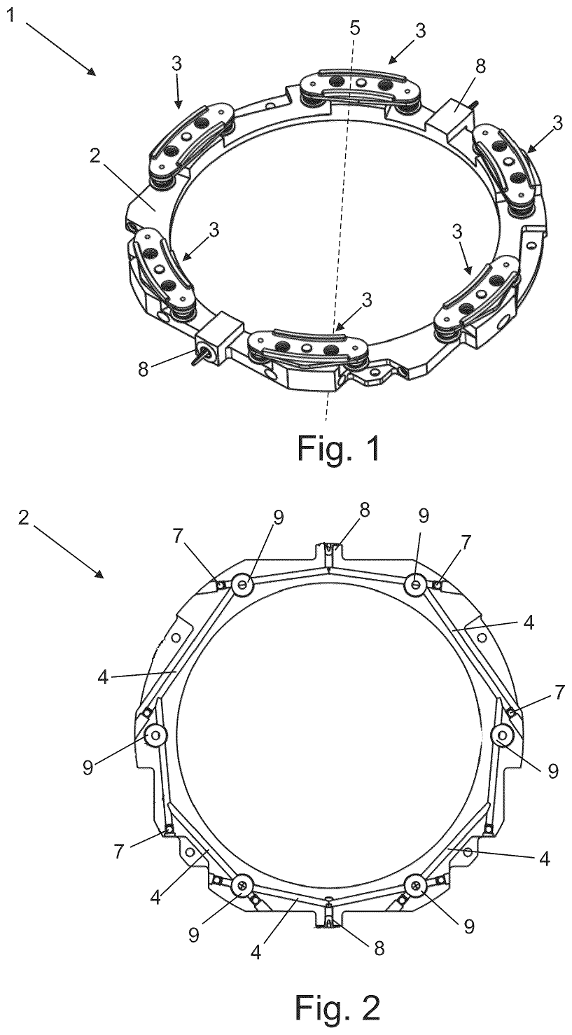

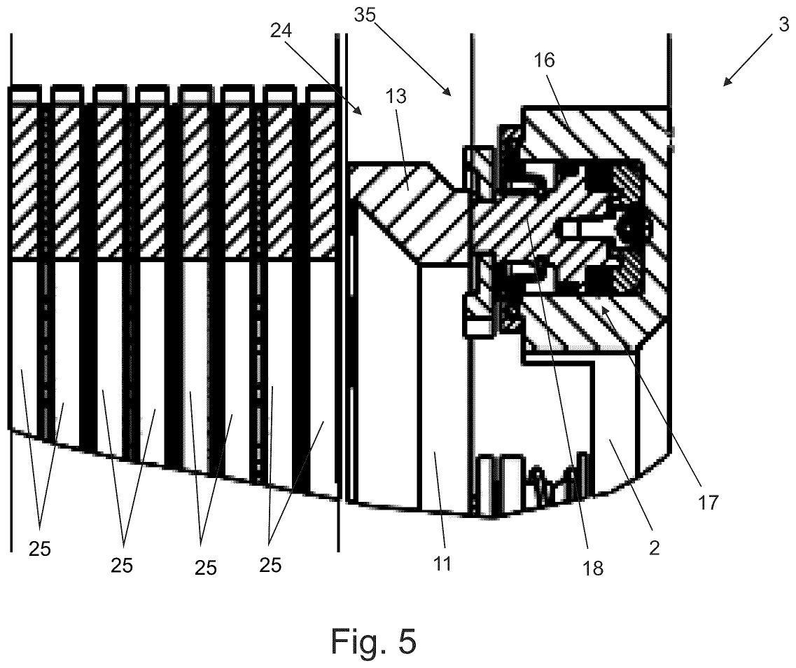

FIG. 1 shows a perspective plan view of a multi-piston disengagement system 1. The multi-piston disengagement system 1 can be integrated into a brake arrangement of a vehicle. The brake arrangement is arranged in a wet space of the vehicle, which can be and/or is filled with a wet space fluid, e.g., with a first hydraulic fluid. The brake arrangement includes a braking device which is designed as a wet-running friction disc brake with a plurality of friction discs 25 (FIG. 5). The multi-piston disengagement system 1 is designed to activate the braking device by transmitting an actuation force.

The multi-piston disengagement system 1 includes an annular housing 2 and a plurality of, for example six, hydraulic actuation assemblies 3. The actuation assemblies 3 are arranged at regular intervals from one another on the annular housing 2 in the circumferential direction of the annular housing 2 and are accommodated in sections therein. The annular housing 2 has a main axis 5 which defines an axial direction 6 (FIG. 4).

FIG. 2 shows an axial section through the annular housing 2. It has two fluid inlets 8 and several flow channels 4. The flow channels 4 are fluidically connected to one another at one end and closed at the other end by a closure body 7. The flow channels 4 are integrated in the annular housing 2. The two fluid inlets 8 are fluidically connected to the flow channels 4. Through the fluid inlets 8, a fluid different from the wet space fluid, in particular a second hydraulic fluid, can be introduced into the flow channels 4.

Pressure chambers 9 are integrated in the annular housing 2, and each actuation assembly 3 is assigned exactly one pressure chamber 9. The pressure chambers 9 are fluidically connected to the flow channels 4 and can thus be filled with the fluid.

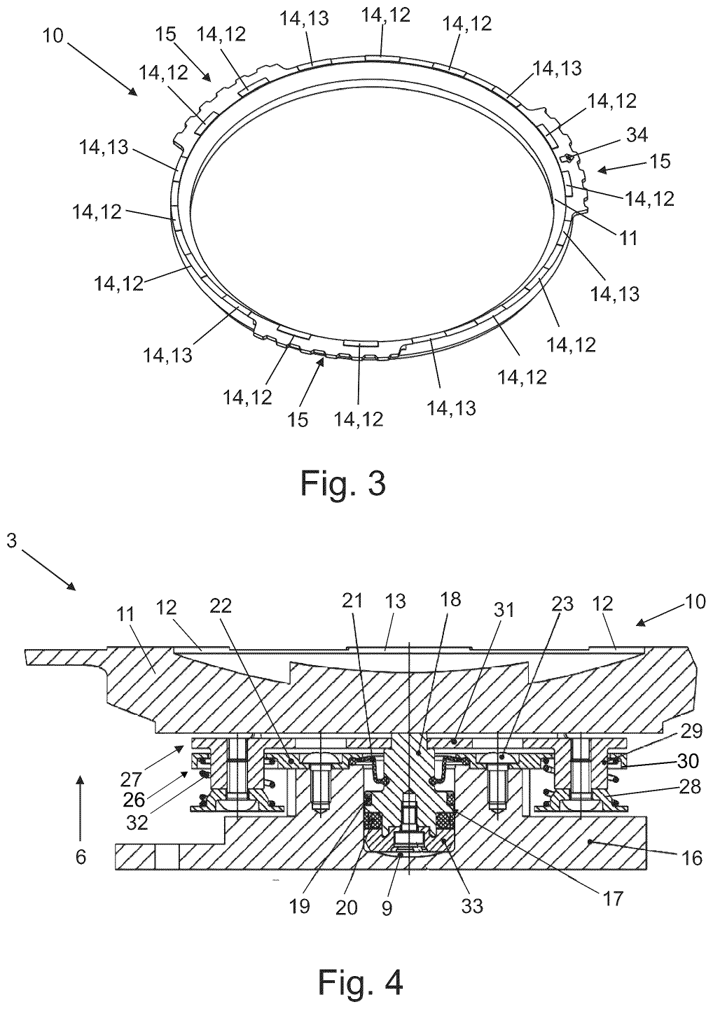

FIG. 3 shows a force distribution device 10 of the multi-piston disengagement system 1 in a perspective plan view: The force distribution device 10 includes a force distribution ring 11 and a plurality of force introduction regions 14 arranged thereon. The number of force introduction regions 14 is a multiple of the number of pistons 18 present in the multi-piston disengagement system 1. In a contact position 24 of the force distribution device 10 (see FIG. 5), the force introduction regions 14 press against friction discs 25 of the braking device and thus introduce the transmitted actuation force into the friction discs 25.

The force introduction regions 14 are designed as teeth 12 with a first height and as teeth 13 with a second height. The first height is greater than the second height. There are a plurality of, e.g., a total of six teeth 13 with the second height and a plurality of, e.g., a total of twelve teeth 12 with the first height. The teeth 12, 13 are arranged at a distance from one another in the circumferential direction on an upper side of the force distribution ring 11 directed in the axial direction 6 and protrude therefrom.

The force distribution device 10 has a plurality of, e.g., three, centering sections 15, by means of which the force distribution device 10 can be arranged coaxially and/or concentrically to the main axis 5 and/or to the annular housing 2 (FIG. 1). The centering sections 15 are arranged at a distance from one another in the circumferential direction on the force distribution ring 11 and protrude radially therefrom. The centering sections 15 are designed as toothing regions by means of which the force distribution device 10 can engage in corresponding toothings of a housing of the brake arrangement. During the engagement, the force distribution device 10 is movable in the axial direction and secured against rotation about the main axis 5.

FIG. 4 shows a sectional view of one of the hydraulic actuation assemblies 3 of the multi-piston disengagement system 1. The actuation assembly 3 has a housing section 16, which is a component of the annular housing 2. The pressure chamber 9, which is assigned to the actuation assembly 3 shown, is integrated in the housing section 16.

The actuation assembly 1 includes a piston assembly 17. The piston assembly 17 has a piston 18. A guide body 33 is screwed to the piston 18. The piston 18 and the guide body 33 are arranged together in the pressure chamber 9 so as to be axially movable. During the axial movement, the guide body 33 guides the piston 18.

The actuation assembly 1 includes a first sealing device 19, a second sealing device 20 and a third sealing device 21. The first sealing device 19 and the second sealing device 20 are designed as O-rings and are arranged on the piston 18 in an immovable manner. They seal the piston 18 against the pressure chamber 9. The first sealing device 19 also functions as a sliding band, which facilitates the sliding of the piston 18 during axial movement. The third sealing device 21 is an axial-translational seal which seals the pressure chamber 9 from the wet space of the vehicle.

The actuation assembly 3 includes a retaining plate 22 which is arranged in the axial direction 6 on the housing section 16 and is screwed thereto by means of two screws 23. When hydraulic pressure is applied by means of the fluid introduced into the pressure chamber 9, the piston 4 can carry out an actuation stroke relative to the housing section 16 and to the retaining plate 22 attached thereto. The actuation stroke moves the piston 18 into an actuation position 35 (FIG. 5) in which the braking device is actuated.

The actuation assembly 3 has a spring assembly 26. The spring assembly 26 includes a spring sheet 27 and two spring plates 28. The spring sheet 27 has a surface section 31 and two axis sections 29 which protrude from the surface section 31 in an axially opposite direction. The surface section 31 is arranged in the axial direction 6 in front of the retaining plate 22, extending parallel to the latter. The retaining plate 22 has two recesses 30 through which the axis sections 29 protrude in the opposite axial direction. The spring plates 28 are container-shaped and are attached at the ends to the axis sections 29 via a screw connection.

The spring assembly 26 has two spiral springs 32. The spiral springs 32 are arranged on the axis sections 29 between the retaining plate 22 and the spring plates 28. The spiral springs 32 are supported with one axial end on the retaining plate 22 and with the other end on the spring plate.

The piston 18 is connected to the surface section 31 of the spring sheet 27 in a form-fitting and/or force-fitting manner. During the actuation stroke of the piston 18, the spring sheet 27 is moved together with the spring plates 28 in the axial direction 6 against a preload of the spiral springs 32. The spiral springs 32 act as return devices which return the piston 18 in the opposite axial direction when the hydraulic pressure is released.

The actuation assembly 3 includes the force distribution device 10. This is arranged in the axial direction 6 directly in front of the piston 18. During the actuation stroke of the piston 18, the latter presses against the force distribution ring 11, so that the force distribution device 10 is moved together with the piston 18 in the axial direction 6 and carries out the actuation stroke.

The force distribution device 10 is arranged concentrically and/or coaxially to the annular housing 2 in relation to the main axis 5 (FIG. 1). With the toothing regions of the centering sections 15 (FIG. 3), the force distribution device 10 can engage in a rotationally fixed manner in corresponding toothings of a housing of the brake arrangement, wherein it is movable in the axial direction 6.

The force distribution ring 11 is arranged and aligned relative to the annular housing 2 such that each piston assembly 3 is assigned a total of three teeth 12, 13. In detail, each piston assembly 3 is assigned exactly two teeth 12 with the first, greater height and exactly one tooth 13 with the second, smaller height. The tooth 13 with the second height is arranged in the axial direction 6 directly in front of the piston 18. The other two teeth 12 with the first height are arranged at a distance from the tooth 13 with the second height. As can be seen from FIG. 3, a marking 34 in the form of an arrow is arranged on the force distribution ring 11, which facilitates and ensures the positioning of the force distribution device 10 relative to the annular housing 2 (FIGS. 1 and 2) and the piston assemblies 3, as described above.

FIG. 5 shows the friction discs 25 of the braking device, the piston assembly 17 with the piston 18 of an actuation assembly 3 and the force transmission device 10. The piston 18 is arranged in the actuation position 35, in which it presses against the force transmission device 10, with the result that the latter is arranged in the contact position 24. In the contact position 24, the actuation force is transmitted to the braking device by means of the force introduction regions 14, in particular via the teeth 12, 13, thus actuating the braking device. The friction discs 25 are frictionally engaged with one another via the introduction of the actuation force, and a braking force can be generated to brake the vehicle.

The distribution of the actuation force to the teeth 12, 13 acting as the force introduction regions 14 depends on a level of pressure for hydraulically pressurizing the piston 18. Up to a defined limit pressure, only the two teeth 12 assigned to an actuation assembly 3 which have the first, greater height (see FIG. 4) are pressed against the friction discs 25, so that they transmit the actuation force in a proportionate manner. As a result, the actuation force transmitted by the piston 18 can be distributed between the two teeth 12 with the first height. If the limit pressure is exceeded, the piston is moved further in the axial direction 6 so that it presses more strongly against the force transmission device 10. As a result, the tooth 13 assigned to the actuation assembly 3 with the second, lower height is also pressed against the friction discs 25, so that it also transmits the actuation force in a proportionate manner. In this case, the actuation force transmitted by the piston 18 is divided between all three teeth 12, 13.

In summary, the force distribution device 10 distributes and thus harmonizes an actuation force transmitted by the pistons 18 of the multi-piston disengagement system 1 to the force introduction regions 14 depending on the pressure for hydraulically pressurizing the pistons 18. A surface area of the friction discs can be subjected to the actuation force evenly and partial overloading of the linings and friction surfaces of the friction discs, and the associated underloading of other areas of the friction discs, can be avoided.

### REFERENCE NUMERALS

1 Multi-piston disengagement system
2 Annular housing
3 Actuation assembly
4 Flow channels
5 Main axis
6 Axial direction
7 Closure body
8 Fluid inlets
9 Pressure chambers
10 Force distribution device
11 Force distribution ring
12 Teeth with first height
13 Teeth with second height
14 Force introduction regions
15 Centering section
16 Housing section
17 Piston assembly
18 Piston
19 First sealing device
20 Second sealing device
21 Third sealing device
22 Retaining plate
23 Screws
24 Contact point
25 Friction disc
26 Spring assembly
27 Spring sheet
28 Spring plate
29 Axis section
30 Recesses
31 Surface section
32 Spiral spring
33 Guide bodies
34 Marking
35 Actuation position

1. A multi-piston disengagement system for actuating a braking device of a vehicle,
having an annular housing, wherein the annular housing has a main axis, wherein the main axis defines an axial direction,
wherein the annular housing comprises a plurality of housing sections, wherein a pressure chamber which can be filled or is filled with a fluid is arranged in each housing section,
having a plurality of hydraulic actuation assemblies,
wherein each actuation assembly is assigned a housing section,
wherein each actuation assembly has a piston assembly comprising a piston, wherein the piston is arranged in the pressure chamber so as to be movable in the axial direction and, upon application of a hydraulic pressure, can carry out an actuation stroke for introducing an actuation force into the braking device, and
wherein the multi-piston disengagement system has a force distribution device for distributing the actuation force introduced into the braking device.

2. The multi-piston disengagement system according to claim 1, wherein the force distribution device is designed to introduce the actuation force into the braking device in several force introduction regions.

3. The multi-piston disengagement system according to claim 2, wherein the force distribution device comprises the force introduction regions, wherein a number of the force introduction regions is a multiple of a number of pistons of the multi-piston disengagement system, wherein the multiple is double or triple.

4. The multi-piston disengagement system according to claim 2, wherein the force distribution device comprises a force distribution ring, wherein the force distribution ring is arranged coaxially or concentrically to the annular housing in relation to the main axis.

5. The multi-piston disengagement system according to claim 1, wherein the force distribution device is in an operative connection with the piston or is movable together with the piston in the axial direction for transfer into a contact position with the braking device.

6. The multi-piston disengagement system according to claim 2, wherein each piston assembly is spatially and functionally assigned a plurality of force introduction regions.

7. The multi-piston disengagement system according to claim 4, wherein the force introduction regions are formed by teeth, wherein the teeth are arranged on the force distribution ring and protrude therefrom in the axial direction.

8. The multi-piston disengagement system according to claim 7, wherein some teeth have a first height and the other teeth have a second height, wherein each piston assembly is spatially and functionally assigned a plurality of teeth with the first height and at least one tooth with the second height.

9. A braking system for a vehicle having the multi-piston disengagement system according to claim 2 and having a braking device for braking a wheel of the vehicle.

10. The braking system according to claim 9, wherein, in a contact position, the force distribution device is arranged in contact with the braking device in some or all force introduction regions depending on a hydraulic pressurization of the pistons.

11. A multi-piston disengagement system for actuating a vehicle braking device, comprising:
an annular housing comprising:
a main axis that defines an axial direction;
a plurality of housing sections comprising respective pressure chambers arranged for filling with a fluid;
a plurality of hydraulic actuation assemblies, each comprising a piston arranged axially movable in a one of the respective pressure chambers and, when a hydraulic pressure is applied, arranged to apply an actuation force; and
a force distribution device for distributing the actuation forces from respective pistons to the vehicle braking device.

12. The multi-piston disengagement system of claim 11 wherein the force distribution device is operatively connected to the respective pistons or is movable together with the respective pistons into a contact position with the vehicle braking device.

13. The multi-piston disengagement system of claim 11, wherein the force distribution device distributes the actuation forces to the vehicle braking device in several force introduction regions.

14. The multi-piston disengagement system of claim 13 wherein each of the respective pistons is spatially and functionally assigned a plurality of the several force introduction regions.

15. The multi-piston disengagement system of claim 13, wherein a quantity of the several force introduction regions is two times or three times a quantity of the respective pistons of the plurality of hydraulic actuation assemblies.

16. The multi-piston disengagement system of claim 13, wherein the force distribution device comprises a force distribution ring arranged coaxially or concentrically to the annular housing in relation to the main axis.

17. The multi-piston disengagement system of claim 16, wherein the several force introduction regions are formed by teeth arranged on the force distribution ring and axially protruding therefrom.

18. The multi-piston disengagement system of claim 17, wherein:
a first plurality of the teeth has a first height;
a second plurality of the teeth has a second height; and
each of the respective pistons is spatially and functionally assigned a plurality of the first plurality of the teeth and at least one of the second plurality of the teeth.

19. A braking system for a vehicle comprising:
the multi-piston disengagement system of claim 11; and
the vehicle braking device for braking a wheel of the vehicle.
